(19) United States
(12) Patent Application Publication
(10) Pub. No.: US 2012/0031251 A1
(43) Pub. Date: Feb. 9, 2012

(54) PAPERBOARD SHEET SLITTER-SCORER APPARATUS AND CONTROL METHOD FOR CORRECTING THE POSITIONS OF SLITTER KNIVES AND SCORERS THEREOF

(76) Inventors: Hiroki Momonaka, Kasugai-shi (JP); Michio Suzuki, Kasugai-shi (JP); Kazuya Sawayama, Kasugai-shi (JP)

(21) Appl. No.: 13/196,319

(22) Filed: Aug. 2, 2011

(30) Foreign Application Priority Data
Aug. 6, 2010 (JP) 2010-177801

(51) Int. Cl. B26D 11/00

(52) U.S. Cl. 83/864

(57) ABSTRACT

A slitter-scorer apparatus is provided, capable of effectively positioning slitter knives in the width direction so that a paperboard sheet of a desired sheet width can be obtained. The slitter scorer apparatus 1 of the present invention comprises a plurality of slitters 6 having slitter knives 80 and 82 paralelly disposed in the width direction relative to the supply direction of a paperboard sheet, for cutting the sheet; slitter width-direction moving means 90, 112, 104, 84, 114, and 16 for respectively independently moving the plurality of slitters in the width direction of the sheet; and a control means for selecting a utilized slitter from among the plurality of slitters based on a production order, calculating a width-direction correction amount relative to an initial position based on the desired paperboard sheet width-direction dimension according to the amount of shearing by the slitter knife, and controlling the slitter width-direction moving means so as to position the slitter knives at a position based on that calculated correction amount.

### BACKGROUND OF THE INVENTION

1. Field of the Invention

The present invention relates to a cardboard sheet slitter-scorer apparatus and control method for correcting the positions of slitter knives and scorers thereof, and more particularly to a paperboard sheet slitter-scorer apparatus in which a plurality of slitters are placed in the width direction.

2. Description of the Related Art

Known conventional slitter-scorer apparatuses include those in which a slitter knife is positioned in a predetermined position in the width direction, in accordance with the number of manufactured sheets, to perform cutting work (e. g., Japanese Patent Publication No. 3717167).

Japanese Patent Examined Publication No. 1-014017 discloses a tool positioning method whereby multiple tools are transferred from a standby area to a setting area and positioned at a predetermined position on a sheet within the setting area using as a reference the position of an origin point between the standby area and the setting area.

Here, in a slitter-scorer apparatus such as that disclosed in Japanese Patent Publication No. 3717167 above, the above-described “predetermined position” is defined by assuming there are no dimensional changes associated with shearing or the like of the paperboard sheet caused by the cutting work of the slitter knife. However, it normally occurs that sheets are sheared due to factors such as slitter knife thickness, reducing the width-direction dimension of sheets after paperboard sheet splitting (after slitting) to smaller than the desired sheet dimension.

For example, using “d” as the amount of dimensional change caused by shearing, etc. of paperboard sheets by slitter knives, and “L” as the desired sheet width dimension, when two paperboard sheets are manufactured, the paperboard sheets are respectively sheared by slitter knives SN6, SN0, and SN5, as shown in FIG. 9(a), and the respective sheet width dimensions after cutting become “L-d,” which is smaller than the desired width dimension L; when three paperboard sheets are manufactured, the paperboard sheets are respectively sheared by slitter knives SN6, SN2, SN1, and SN5, as shown in FIG. 9(b), and the respective sheet width dimensions after cutting become “L-d,” which is smaller than the desired width dimension L.

The initial position of the slitter knives is therefore conventionally adjusted after installation of the slitter-scorer apparatus by loading all of the slitter knives in the slitter knife positions at which it is assumed there would be no dimensional change, then running sheets through the machine (initial adjustment production) so that the desired sheet width could be obtained. Specifically, an operator measured the width of sheets obtained when sheets are actually run through the machine, adjusting the position of the slitter knives to correct for the missing part of the desired sheet width. Repeated operations are also required to actually run sheets through the machine and measure the sheets obtained to confirm whether the desired sheet width had been obtained at that adjusted slitter knife position. This presented the problem that significant time and labor are required for such adjustment and operations by operators.

The present invention is therefore undertaken to resolve problems with the conventional art, and has the object of providing a slitter-scorer apparatus and position correction control method for the slitter knife and scorer thereof capable of effectively positioning slitter knives in the width direction so as to obtain paperboard sheets of a desired sheet width.

### SUMMARY OF THE INVENTION

In order to achieve this object, the present invention provides a slitter scorer apparatus for cutting a paperboard sheet continuously supplied along a supply line and scoring the surface thereof, comprising: a plurality of scorers, parallely arrayed in the width direction relative to the paperboard sheet supply direction, for scoring the surface of the paperboard sheet; a plurality of slitters parallely arrayed in the width direction relative to the paperboard sheet supply direction, having slitter knives for cutting the paperboard sheet; a scorer width-direction moving means for independently moving each of the plurality of scorers in the width direction of the paperboard sheet; a slitter width-direction moving means for independently moving each of the plurality of slitters in the width direction of the paperboard sheet; and a control means for selecting a utilized slitter from among the plurality of slitters based on a production order, calculating the slitter knives of the selected slitter a width-direction positional correction amount relative to an initial position matched to the desired paperboard sheet dimension in the width direction in accordance with the amount of shearing by the slitter knives, and controlling the slitter width-direction moving means to position the slitter knives at a position based on that calculated correction amount.

According to the present invention thus constituted, for the slitter knives in the utilized slitter, the amount of positional correction in the width direction is calculated according to the amount of shearing by the slitter knives relative to an initial position, together with the desired width dimension of the paperboard sheet; the slitter knives are positioned at positions based on this calculated correction amount, thereby enabling effective positioning of the slitter knives in the width direction so that a desired sheet width can be obtained. As a result, a major reduction of time and labor can be achieved for initial adjustments during machine installation.

Preferably, in the present invention, the control means controls a scorer width-direction moving means by selecting a utilized scorer from among the plurality of scorers based on a production order, calculating a scorer correction amount relative to an initial position matched to the desired paperboard sheet scoring position according to the above-described slitter knife width-direction positional correction amount, and positioning the scorer at a position based on that calculated correction amount.

According to the present invention thus constituted, positioning of scorers in the width dimension can be effectively performed. As a result, a major reduction of time and sheet loss can be achieved for initial adjustments at the time of machine installation.

Preferably, in the present invention, the control device calculates, sequentially from one side in the width dimension of the slitter-scorer apparatus, a first utilized scorer correction amount, and calculates, sequentially from the other width dimension side of the slitter-scorer apparatus, a second utilized scorer correction amount, then corrects those calculated first and second correction amounts to match the utilized scorer and slitter to the mechanical center, thereby calculating a slitter knife width direction position correction amount and scorer correction amount based on the amount of shearing by the slitter knives.

According to the present invention thus constituted, positional control of slitter knives and scorers can be achieved by a simple control. Also, because the first and second correction amounts are corrected so as to place the utilized scorers and slitter knives based on the mechanical center, it becomes possible to position a slitter knife positioned at the furthest edge on one side of the width direction and a slitter knife positioned at the furthest edge on the other side of the width direction symmetrically about the mechanical center, thereby achieving a uniform width dimension for the trim cut off by the respective slitter knives. The paperboard sheets cut at the outermost side can therefore be prevented from becoming rejected sheets due to loss of trim on one side in the narrow width when a difference occurs between the width dimensions of the trim on the two sides during manufacturing.

Preferably, in the present invention, the control means controls a slitter width-direction moving means and scorer width-direction moving means so as to simultaneously position the utilized slitter knives and utilized scorers.

Preferably, in the present invention, further comprising a warpage amount detection sensor for detecting the amount of paperboard sheet warpage; the control means further corrects the slitter knife shearing amount-based slitter knife width direction positional correction amount according to the amount of paperboard sheet warpage detected by the warpage amount detection sensor.

According to the present invention thus constituted, paperboard sheet of a desired sheet width can be obtained with higher accuracy.

In order to achieve the above object, the present invention provides a method for controlling the positional correction of slitter knives and scorers in a slitter scorer apparatus, comprising: a plurality of slitters having slitter knives for cutting a sheet parallely arrayed so as to be independently movable in the width direction relative to the direction of supply of the paperboard sheet; and a plurality of scorers for scoring the surface of a sheet parallely arrayed so as to be independently movable in the width direction relative to the direction of supply of the paperboard sheet: said method comprising the steps of: selecting the utilized slitter and scorer from among the plurality of slitters and scorers based a production order; calculating a first correction amount for each of the utilized scorers based on the amount of shearing by the slitter knives sequentially from one side in the width direction of the slitter scorer apparatus; calculating a second correction amount for each of the utilized slitter knives based on the amount of shearing by the slitter knives sequentially from the other side in the width direction of the slitter scorer apparatus; correcting the calculated first and second correction amounts to align the utilized scorers and slitter knives to the mechanical center, and calculating slitter knife and scorer correction amounts relative to an initial position based on the desired dimension in the paperboard sheet width direction; and positioning the utilized slitters and scorers at a position based on that calculated correction amounts.

According to the present invention thus constituted, a slitter knife and scorer correction amounts are calculated relative to an initial position based on the desired paperboard sheet dimension in the width direction for the slitter knife of the utilized slitter; since the slitter and scorer are positioned at a position based on this calculated correction amount, it is possible to position the slitter knife effectively in the width direction so as to obtain a desired sheet width; it is also possible to effectively position the scorer in a desired scoring position. As a result, a major reduction in time and labor can be achieved when making initial adjustments at the time of machine installation. Also, because the first and second correction amounts are corrected so as to place the utilized scorers and slitter knives based on the mechanical center, it becomes possible to position a slitter knife positioned at the furthest edge on one side of the width direction and a slitter knife positioned at the furthest edge on the other side of the width direction symmetrically about the mechanical center, thereby achieving a uniform width dimension for the trim cut off by the respective slitter knives. Therefore the width dimension of trims cut by the respective slitter knives are respectively uniform, such that serpentine motion by the paperboard sheet in the supply direction during manufacturing can be prevented.

The present invention enables effective positioning of slitter knives in the width direction so that paperboard sheets of a desired sheet width can be obtained. Positioning of scorers can also be effectively performed in the width direction to perform scoring work at desired positions on the paperboard sheet.

### BRIEF DESCRIPTION OF THE DRAWINGS

FIG. 1: An overview side elevation of a slitter-scorer apparatus according to an embodiment of the present invention.

FIG. 2: An overview front elevation of a slitter-scorer apparatus according to an embodiment of the present invention.

FIG. 3: A figure viewed from the circumferential side of a slitter knife showing an example of a slitter knife used in a slitter-scorer apparatus according to an embodiment of the present invention.

FIG. 4: A block diagram showing the overview structure of a slitter-scorer apparatus according to an embodiment of the present invention.

FIG. 5: A flowchart showing position correction control in the width direction of the scorer and the slitter of a slitter-score apparatus according to an embodiment of the present invention.

FIG. 6: A plan view schematically showing the position of a slitter and a scorer positioned by position correction control according to an embodiment of the present invention for three paperboard sheets manufacturing (FIG. 6(a)) and for four paperboard sheets manufacturing (FIG. 6(b)).

FIG. 7: A diagram similar to FIG. 3, in which the state of the slitter knife after wear or after grinding is shown by a dot and dash line.

FIG. 8: A diagram seen from the sheet supply direction showing a laser sensor for measuring the amount of warpage in the paperboard sheet, and the state of the paperboard sheet warpage.

FIG. 9: A top view schematically showing a slitter position and paperboard sheet for the purpose of explaining the amount of shearing of the paperboard sheet by a slitter knife and the sheet width associated with that shearing.

### DETAILED DESCRIPTION OF PREFERRED EMBODIMENTS OF THE INVENTION

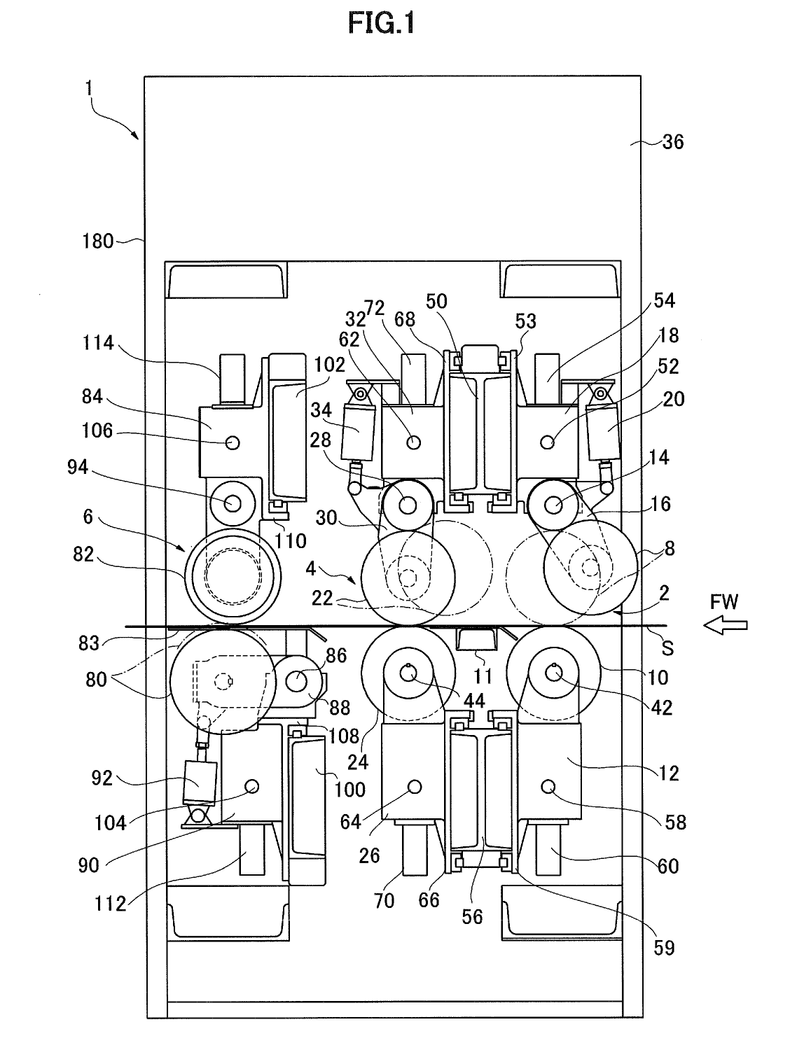

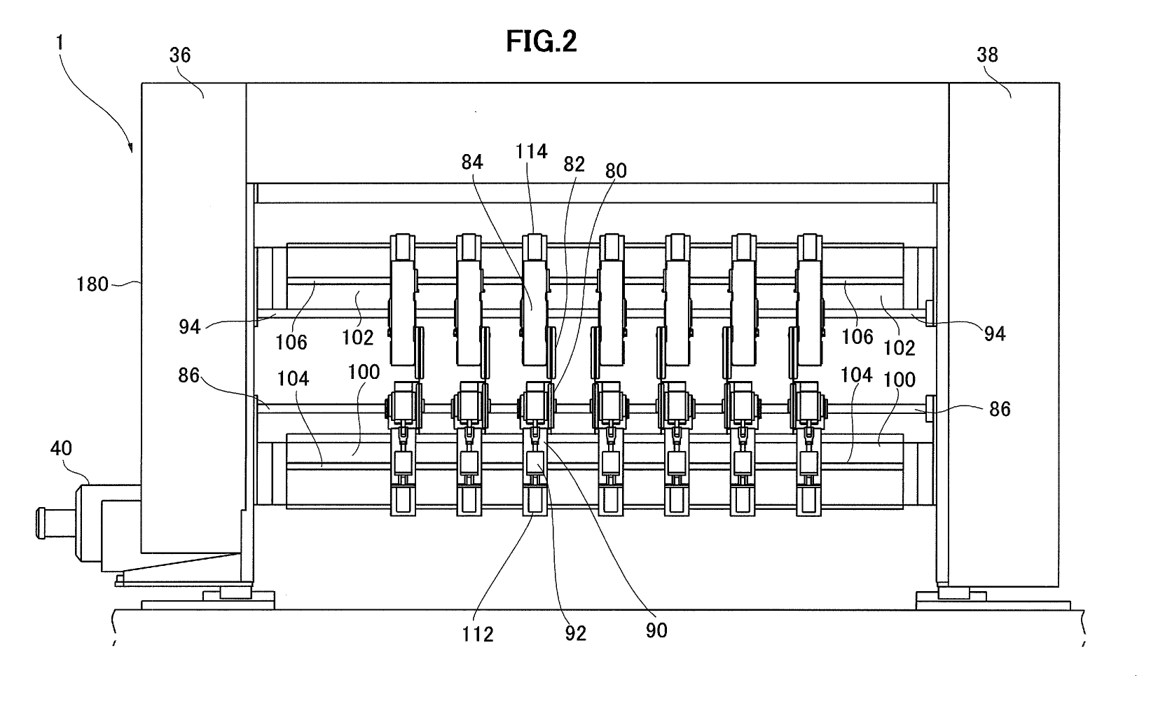

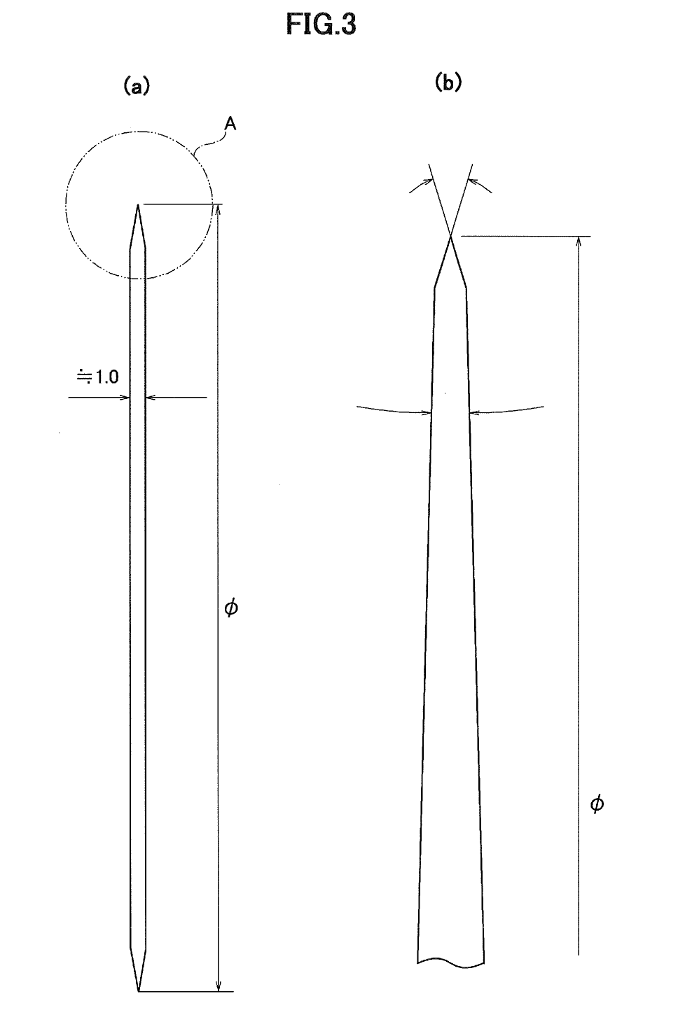

Next, referring to the attached drawings, a slitter-scorer apparatus according to an embodiment of the present invention will be described. First, referring to FIGS. 1 through 3, the basic structure of a slitter-scorer apparatus according to an embodiment of the present invention will be described. FIG. 1 is an overview side elevation showing a summary of a slitter-scorer apparatus according to an embodiment of the present invention; FIG. 2 is an overview front elevation showing a summary of a slitter-scorer apparatus according to an embodiment of the present invention; FIG. 3 is a front elevation showing an example of a slitter knife used in a slitter-scorer apparatus according to an embodiment of the present invention.

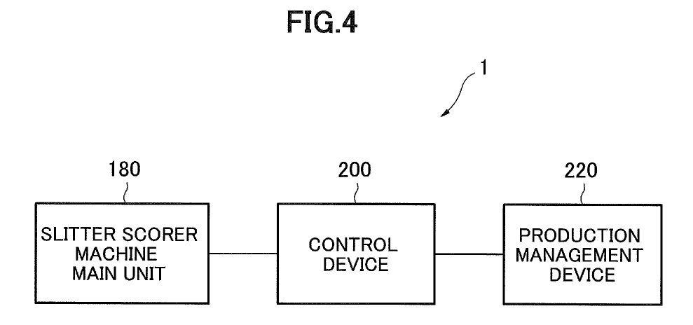

As shown in FIG. 1, Reference Numeral 1 indicates a slitter-scorer apparatus according to the present embodiment. This slitter-scorer apparatus 1 is provided on a paperboard sheet supply line at the dry end of a corrugator; a single facer, double facer, or the like (not shown) are placed on the upstream side thereof. The paperboard sheet S is supplied from this single facer or the like to a slitter-scorer apparatus 1. FIG. 1 shows the supply direction FW thereof. A cutter, stacker, or the like (not shown) are placed downstream of the corrugator. The paperboard sheet S is arranged to be transported by a suction conveyor (not shown). Note that the slitter-scorer apparatus 1 has a control device 200, as explained below in FIG. 4. Below, the constitution of a mechanical main unit 180 in the apparatus 1 will be described.

The slitter-scorer apparatus 1 according to the present embodiment comprises an upstream scorer 2 arrayed along the supply direction FW, a downstream scorer 4, and a slitter 6 arrayed on the downstream side of 4.

First, referring to FIG. 1, the constitution of the upstream scorer 2 and the downstream scorer 4 will be described.

As shown in FIG. 1, the upstream scorer 2 has an upper scoring roll 8 and a lower scoring roll 10; a plurality of groups of these rolls 8 and 10 are placed in the width direction of the slitter-scorer apparatus 1.

A raised portion continuous in the circumferential direction thereof is formed at approximately the center of the circumferential surface of the upper scoring roll 8, while an indented portion continuous in the circumferential direction thereof is formed at approximately the center of the circumferential surface of the lower scoring roll 10. The bottom surface of the paperboard sheet S is guided by a guide 11; the circumferential surface of the lower scoring roll 10 is disposed at a position such as that shown in FIG. 1 to match the bottom surface of the supplied paperboard sheet S, and is supported by a yoke 12, described below, so as to be unable to move in the up/down direction of the apparatus 1.

At the same time, the upper scoring roll 8 is linked to a pivoting lever 16 capable of pivoting about a rotating drive shaft 14, described below. This pivoting lever 16 is arranged to pivot by the action of an air cylinder 20 linked to a yoke 18; with this pivoting, the upper scoring roll 8 is able to move to a scoring position such as that shown by the dot and dash line in FIG. 1, and to a standby position such as that shown by the solid line in FIG. 1.

Similar to the upstream scorer 2, the downstream scorer 4 also has an upper scoring roll 22 and a lower scoring roll 24. Similar to the upstream scorer 6, the lower scoring roll 24 is supported by a yoke 26 so as to be unable to move in the up/down direction of the apparatus 1. Similar to the upstream-side scorer 6, the upper scoring roll 22 is arranged to be movable to a position at which scoring is implemented and to a standby position by an air cylinder 34 linked to a pivoting bar 30 capable of pivoting about a rotating drive shaft 28 (described below) and a yoke 32.

Rotating drive shafts 14 and 28 are respectively erected on each frame 36 and 38 at both sides in the width direction of apparatus 1 (see FIG. 2), and extend in the width direction. Each of the rotating drive shafts 14 and 28 is respectively linked via a power transmission mechanism having a timing belt and a gear mechanism to a rotating drive motor 40 (see FIG. 2), and linked via a timing belt and a pulley to each of the upper scoring rolls 8 and 22. Each upper scoring roll 8 and 22 rotates clockwise in FIG. 1 under the rotation of this rotating drive motor 40.

At the same time rotating drive shafts 42 and 44, erected on each frame 36 and 38 (see FIG. 2) and extending in the width direction, are similarly provided on lower scoring rolls 10 and 24, respectively. These rotating drive shafts 42 and 44 are linked to the rotating drive motor 40 (see FIG. 2), and each upper scoring roll 22 and 24 is rotated counterclockwise in FIG. 1 by the rotation of the rotating drive motor 40.

Next, a structure for respectively moving the upper scoring rolls 8 and 10, of which plurality of sets are placed in the width direction in the upstream scorer 2 will be described.

Guides 50 and 56, installed on each of the frames 36 and 38 (see FIG. 2) and extending in the width direction, and threaded shafts 52 and 58, installed on each of the frames 36 and 38 (see FIG. 2) and extending in the width direction, are respectively placed on the upper and lower parts of the machine 1 in order to respectively move the plurality of upper scoring rolls 8 and 10 independently in the width direction of the machine 1. Each of these threaded shafts 52 and 58 are placed so as to penetrate each yoke 18 and 12. Each yoke 18 and 12 is provided with guide members 53 and 59, which slide with guide units 50 and 56 so as to be guided in the width direction along the guide units 50 and 56.

Width direction positioning motors 54 and 60 are respectively placed on the yokes 18 and 12. The output shafts of these motors 54 and 60 are linked to rotors, which have a threaded engagement with the above-described threaded shafts 52 and 58; each yoke 18 and 12 is constituted to respectively move independently in the width direction along the guides 50 and 56 by rotating each rotating unit through the rotational drive supplied by each motor 54 and 60.

Next, the upper scoring rolls 22 and 24 in the downstream scorer 4 are also respectively moved in the width direction by the same type of structure as that found in the upstream scorer 2. That is, the yokes 32 and 26 are respectively constituted to be moved independently in the width direction along the guide units 50 and 56 by the screw shafts 62 and 64, the guide members 66 and 68, the width direction positioning motors 70 and 72, and the rotating units which thread-engage the threaded shafts 62 and 64.

The plurality of sets of upper and lower scoring rolls are selectively operated and positioned in the width direction according to each order such as the number of paperboard sheets manufactured, the number of scores, and slit forming width.

Next, referring to FIGS. 1 through 3, the constitution of the slitter 6 will be described.

The slitter 6 has a slitter knife 80 and a slitter knife receiving member 82.

As shown in FIG. 3(a), the slitter knife 80 is a disk-shaped rotating knife, of a thin profile throughout, with a blade thickness of approximately 1 mm and a predetermined taper angle in the direction of the blade edge. As shown in FIG. 3(b), a predetermined very small angle is imparted to the blade edge at the circumference thereof.

A channel, continuous in the circumferential direction, is formed at approximately the center portion of the circumferential surface of the slitter knife receiving member 82. As will be described below, the slitter knife 80 is constituted to move up and down, and the blade edge of the slitter knife 80 penetrates and engages the channel in the slitter knife receiving member 82, thereby slitting (cutting) the paperboard sheet S. The bottom surface of the sheet S is guided by the guide 83.

The slitter knife receiving member 82 is disposed at a position such as that shown in FIG. 1 so that its circumferential surface matches the top surface of the supplied paperboard sheet S, and is supported by a yoke 84, described below, so as to be unable to move in the up and down direction of the apparatus 1.

At the same time, the slitter knife 80 is linked to a pivoting lever 88 capable of pivoting about a rotational drive shaft 86, described below. This pivoting lever 88 is arranged to pivot by the action of an air cylinder 92 linked to a yoke 90; in connection with this pivoting, the slitter knife 80 is able to move to a slitting position such as that shown by the dot and dash line in FIG. 1, and to a standby position such as that shown by the solid line in FIG. 1.

The rotational drive shaft 86, as shown in FIG. 2, is installed on each of the frames 36 and 38 on the apparatus 1, and extends in the width direction. This rotational drive shaft 86 is linked to the rotating drive motor 40 shown in FIG. 2 via a power transmission mechanism having a timing belt and a gear mechanism, and is linked to the slitter knife 80 via a transmission belt and a pulley. The slitter knife 80 rotates counterclockwise in FIG. 1 by the rotation of this rotating drive motor 40.

On the slitter knife receiving member 82 side, as well, a rotational drive shaft 94 installed on each frame 36 and 38 (see FIG. 2) and extending in the width direction, is provided so as to penetrate the bottom end portion of the yoke 84. The slitter knife receiving member 82 is linked to this rotational drive shaft 94 via a transmission belt and pulley. In the same manner as described above for the rotational drive shaft 86, the rotational drive shaft 94 is also linked to the rotating drive motor 40. The slitter knife receiving member 82 rotates clockwise in FIG. 1 by the rotation of this rotating drive motor 40.

Note that in this embodiment, as shown in FIG. 2, seven sets of the slitter knife 80 and the slitter knife receiving member 82 are placed in the width direction of the apparatus 1, but in the structure described above each of the sets is shared.

Next, a structure for respectively moving the slitter knife 80 and the slitter knife receiving member 82, of which plurality of sets are provided, in the width direction will be described.

As shown in FIG. 2, guide units 100 and 102 installed on frames 36 and 38 and extending in the width direction, and threaded shafts 104 and 106 installed on the frames 36 and 38 and extending in the width direction, are respectively placed on the upper part and the lower part of the apparatus 1 to independently move the plurality of slitter knife 80 and slitter knife receiving member 82 sets in the width direction of the apparatus 1. Each of these threaded shafts 104 and 106 are placed so as to penetrate each yoke 90 and 84. Each yoke 90 and 94 is provided with guide members 108 and 110, which slide with guide units 100 and 106 so as to be guided in the width direction along the guide units 100 and 106.

Width direction positioning motors 112 and 114 are respectively placed on the yokes 90 and 84. The output shafts of these motors 112 and 114 are linked to the rotating units which engage the above-described threaded shafts 104 and 106. By rotating each of the rotating units using the rotational drive of the motors 112 and 114, the yoke 90 and 94 is constituted to move independently in along the guide units 100 and 102 in the width direction.

The plurality of slitter knives 80 and slitter knife receiving members 82 are selectively operated and positioned in the width direction according to each order such as the number of manufactured sheets, number of scores, and slit forming width.

As shown in FIG. 4, the slitter-scorer apparatus 1 has a control device 200 connected to the mechanical main unit 180 (FIG. 1 and FIG. 2) of the apparatus 1; this control device 200 controls the operation of the upstream scorer 2, the downstream scorer 4, and the upstream scorer 6 described above. The control device 200 is connected to a production management device 220.

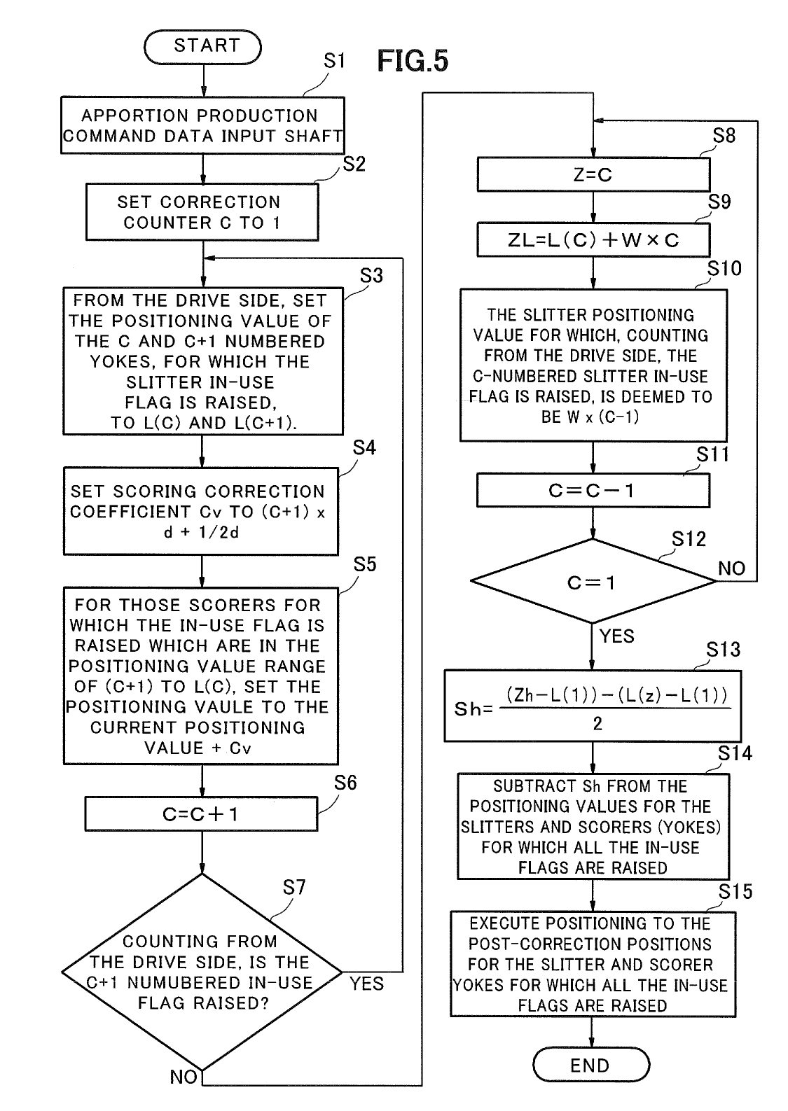

Below, referring to FIG. 5, positioning correction control in the width direction of a slitter and scorer using the slitter-scorer apparatus 1 control device 200 according to the present embodiment will be described.

FIG. 5 is a flowchart showing position correction control in the width direction of the scorer and the slitter of the slitter-score apparatus according to an embodiment of the present invention. In FIG. 5, steps are denoted by “S.”

In the control shown in FIG. 5, a scorer correction position is calculated in S3 through S9; a slitter correction position is calculated in S10 through S12, and the corrected positions are modified in S13 and S14 so that the scorer and slitter at those calculated corrected positions are symmetrically disposed relative to the mechanical center of the apparatus 1 or to the paperboard sheet in the width direction thereof.

First, in S1, production command data input to the production management device 220; this is where width dimension of a base paper (sheet width of the paperboard sheet), number of sheets manufactured (three sheets, four sheets, etc.), slit width (slitter spacing prior to compensation control), scoring position dimension (scoring position prior to correction control), scoring pressure, paperboard sheet fluting, and the like are input.

In S1, the shaft is apportioned according to the input sheet width and number of sheets manufactured. I.e., a determination is made as to which of the plurality of slitters 6 and scorers 2 and 4 to use according to the sheet width and number of sheets manufactured. A in-use flag is raised relative to the slitter 6 and scorer 2, 4 determined for use. For example, if the number of sheets manufactured is three, in-use flags are raised for four slitters.

Next, in S2, a correction counter C (C=1) is set for the slitters and scorers for which a in-use flag is raised in S1.

Next, in S3, counting up from the apparatus 1 drive side (the side on which the motor 40 and frame 36 shown in FIG. 2 are placed), the values for positioning the counter C for the slitter on which the in-use flag is raised, and the C+1 numbered yokes 84 and 90 for the slitter on which the in-use flag is raised (the slitter for which the in-use flag is raised relative to the counter C slitter on the apparatus 1 operating side (the side of the frame 38 on the opposite side to that on which the motor 40 is placed) are set to L(C) and L(C)+1). L(C) and L(C+1) are the initial positions (pre-correction positions) calculated from the base paper width dimension, the number of manufactured paperboard sheets, and the slit width input in S1.

Next, in S4, a scoring correction coefficient Cv is set by the following equation:

Cv=(C+1)×d+½d Eq. (1)

“d” is the amount of shearing of the paperboard sheet by the slitter knife; here it is obtained from experience, experimentation, etc., and a pre-input value is used. For example, with a slitter knife such as that shown in FIG. 3, the amount of shearing from the circumferential portion thereof is 0.1 mm.

Next, in S5, for the scorers for which an in-use flag is raised in S1, those for which the positioning value (the positional dimension of the score input in S1) are within the width direction range of the L(C) and L(C+1) set in S3 have a positioning value LS(C) which is set by the following equation:

LS(C) =“the current positioning value (scoring positional dimension of the input in S1)”+Cv Eq. (2).

Next, in S6, the counter C is incremented by 1, and advancing to S7.

In S7, when the in-use flag is raised for the C+1 numbered slitter, counting from the drive side, returning to S3, and steps S3 through S7 are repeated. In S7, when the in-use flag is not raised for the C+1 numbered slitter, as counted from the drive side, advancing to S8.

For example, when the number of paperboard sheets manufactured is three, each process in S3 through S6 is repeated; when the counter C reaches 4, “counter C+1=5” occurs at S7, and since there is no slitter used on the remaining operating side (there is no slitter for which the in-use flag is raised), advancing to S8.

Next, in S8, the value of counter C is stored in Z.

Next, in S9, the corrected position ZL for a slitter for which the in-use flag has been raised and which is closest to the operating side is stored using the following equation:

ZL=L(C)P+d×(C−1) Eq. (3)

In S9, if the number of manufactured sheets is three, for example, the counter C is at 4 in S9, and the corrected position ZL for a slitter positioned furthest to the operating side for which an in-use flag is raised is set to a value obtained by adding the correction amount “shear amount d×(C−1)” to the initial position L (4) set in S3.

Next, in S10, the positioning value L′(C) of the post-correction C numbered slitter as counted from the drive side is set by the following equation:

L′(C)=L(C)+d×(C−1) Eq. (4)

In other words, a value obtained by adding the correction amount “shear amount d×(C−1)” to the initial position L(C) set in S3 is set as the post-correction positioning value L′(C).

Note that at the stage of first transitioning from S9 to this S10 processing, the C-numbered slitter as counted from the drive side is, for example, at C=4 for three sheets manufacturing, thus becoming the slitter positioned furthest to the operating side for which the in-use flag is raised.

Next, in S11, the value of the correction counter is decremented by C=C−1.

Next, in S12, a determination is made as to whether C=1; if C is determined to equal 1, processing steps S10 through S12 are repeated. The post-correction positioning values L′(C) in S10 are thus respectively set in order from the slitter positioned furthest to the operating side for which the in-use flag is set, up to the slitter positioned furthest to the drive side for which the in-use flag is set.

Next, in S12, when a determination is made that C=1, advancing to S13, and a correction amount Sh for matching each slitter and scorer to the mechanical center of the apparatus 1 is calculated. In other words, in the control shown in FIG. 5 the amount of correction of each slitter and scorer is calculated sequentially from the drive side, therefore each slitter and each scorer is shifted toward the operating side of the apparatus 1, and a correction amount Sh for returning these to the mechanical center is sought in S13.

The correction amount Sh is expressed by the following expression using: the correction position ZL of the slitter positioned furthest to the operating side and stored in S9, the initial position L(1) of the slitter positioned furthest to the drive side, and the position L(Z) of the slitter positioned furthest to the operating side and stored in S8.

Sh=((ZL−L(1))−(L(Z)−L(1))/2 Eq. (5)

Next, in S14, the value Sh is subtracted from each of the post-correction positioning values for all slitters 6 and scorers 2 and 4 for which in-use flags are raised (yokes 84, 90, 15, 12, 32, 26), which is to say from the LS(C) obtained in S5 and the L′(C) obtained in S10. I.e., the final corrected position L″(C) for each slitter on which an in-use flag is raised and the final corrected position of each scorer LS′(C) on which an in-use flag is raised is given by the following expression.

L″(C)=L(C)+d×(C−1)−Sh Eq. (6)

LS′(C)=LS(C)=“score position dimension of the input in S1″+Cv−Sh Eq. (7)

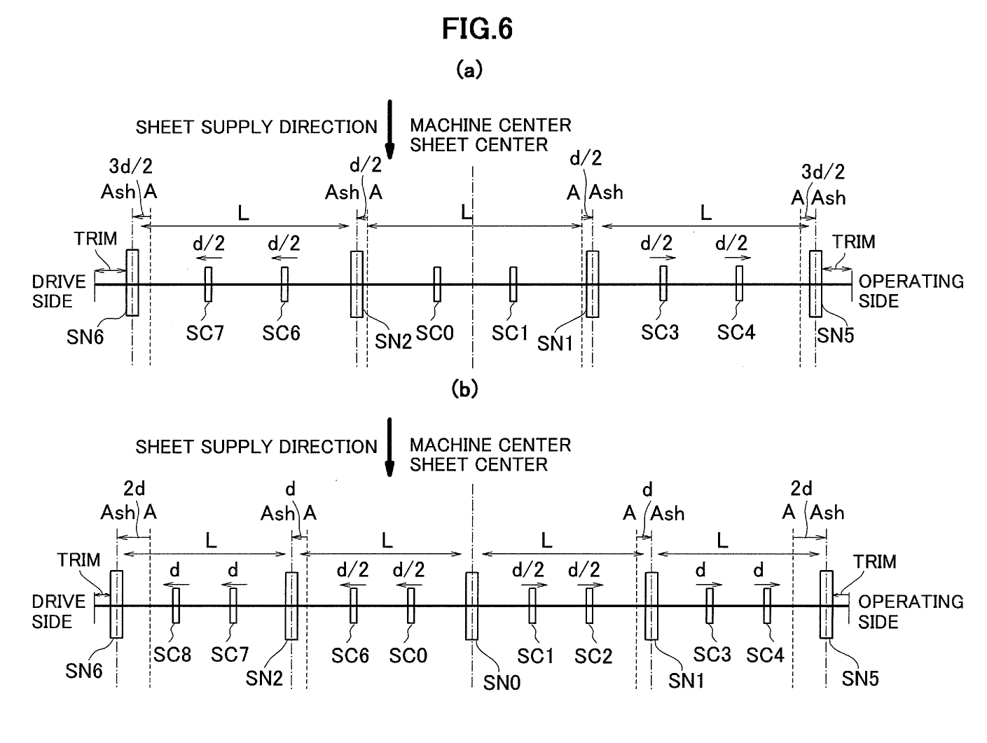

The slitter positioned furthest to the drive side with for which an in-use flag is raised and the scorer positioned furthest to the operating side for which an in-use flag is raised are thus in a symmetrical position relative to the mechanical center, and by making the width of the paperboard sheet trim (see FIG. 6) equal on the drive side and the operating side, serpentine motion of the sheet is avoided during manufacturing.

Next, in S15, all the slitter 6 and the yokes 84, 90, 18, 12, 32, and 26 for which in-use flags are in use are positioned at their respective post-correction positioning values L″(C) and LS′(C).

Next, referring to FIG. 6, the content of the positioning correction control shown in FIG. 5 will be described schematically.

FIG. 6 is plan view schematically showing the position of a slitter and a scorer positioned by position correction control according to an embodiment of the present invention for three paperboard sheets manufacturing (FIG. 6(a)) and four paperboard sheets manufacturing (FIG. 6(b)).

Note that in FIG. 6, the symbol SN represents a slitter knife; SC represents each of the scoring rolls in the scorer; A shows the slitter knife position determined on the assumption that no dimensional change due to shearing or the like of the paperboard sheet by the slitter knives will occur; Ash shows the slitter knife position after executing positional correction control according to an embodiment of the present invention; d shows the amount of shearing of the paperboard sheet by the slitter knives.

First, as shown in FIG. 6(a), when manufacturing three paperboard sheets, the slitter knives SN1 and SN2 on the center side of the paperboard sheet S are both positioned by the positioning correction control discussed above and shown in FIG. 5, from a position A at which there is assumed to be no shear amount, to the position Ash located on the outer side in the width direction by a correction amount of d/2. In the three paperboard sheets manufacturing case, there is no slitter at the center of the sheet, and the amount of correction to the scorers SC0 and SC1 between the slitters SN1 and SN2 on the center side of the sheet S is zero.

At the same time, the scorers SC3, SC4, SC6, and SC7 are each positioned on the outer side in the width direction by the same correction amount as the correction amount toward the outer side in the width direction to the slitter knives SN1 and SN2.

The slitter knife SN6 furthest to the drive side and the slitter knife SN5 furthest to the operating side are respectively positioned at the Ash position toward the outside in the width direction by a correction amount of 3d/2 from the position A at which there is assumed to be no shear.

These correction amounts d/2 and 3d/2 are basically the sum of the sheet shearing amount from the center cross section in the width direction of the slitter knife used to obtain the correction amount (the section through which Ash passes in FIG. 6) to the center of the sheet.

By positioning these slitter knives SN0 through SN6, as shown in FIG. 6(a), the dimension in the width direction of the paperboard sheet S after cutting have the same dimension L as the desired width dimension L.

Next, as shown in FIG. 6(b), when manufacturing four paperboard sheets, the slitter knife SN 0 at the center of the paperboard sheet S is left at its initial position and the slitter knives SN1 and SN2 on both sides thereof are positioned by the positioning correction control discussed above and shown in FIG. 5, from a position A at which there is assumed to be no shear amount, to the position Ash located on the outer side in the width direction by a correction amount of d.

At the same time, the scorers SC1 and SC2 or SC0 and SC6 between the slitter knives SN0 and SN1 or SN2 at the center of the sheet are all positioned on the outside in the width direction by a correction amount d/2. This is to also position the scorers SC1, SC2, SC0, and SC6, which also are positioned to the outer side in the width direction by a correction amount d/2, which is the d/2 sheared amount on one side of the slitter knife SN0 at the center of the sheet.

Also, the slitter knife SN6 furthest to the drive side and the slitter knife SN5 furthest to the operating side are respectively both positioned at the Ash position toward the outside in the width direction by a correction amount 2d from the position A at which it is assumed there is no shear.

The scorers SC3 and SC4 between the slitter knives SN1 and SN5, and the scorers SC7 and SN8 between the slitter knives SN2 and SN6 are each positioned to the outer side in the width direction by the same correction amount as the amount of correction to the slitter knives SN1 and SN2 toward the outer side in the width direction.

In the four paperboard sheets manufacturing case, as well, the correction amounts d and 2d to each of the slitter knives SN1, SN2, SN5, and SN6 are basically the sum of the sheet shearing amount from the center cross section in the width direction of the slitter knife used to obtain the correction amount (the section through which Ash passes in FIG. 6) to the center of the sheet.

By positioning these slitter knives SN0 through SN6, as shown in FIG. 6(b), the dimension in the width direction of the paperboard sheet S after cutting have the same dimension L as the desired width dimension L.

Also, as shown in FIGS. 6(a) and (b), the trim widths are mutually equal on the drive side and on the operating side.

According to the present embodiment described above, use of correction control based on a slitter knife shearing amount such as that shown in FIG. 5 enables the slitter knives SN0 through SN6 to be, as shown for example in FIGS. 6(a) and 6(b) for the three paperboard sheets manufacturing and four paperboard sheets manufacturing cases, positioned at a position such that the dimension in the width direction of the paperboard sheet S after cutting is the same dimension L as the desired dimension L relative to an initial position (a position determined on the assumption that there is no dimensional change due to shearing caused by cutting).

Next, factors affecting the “paperboard sheet shear amount d caused by the slitter knives” will be described. In S4 of FIG. 5 of the present embodiment, a shearing amount d obtained in advance through experience, experimentation, or the like is used to find the above-described correction amounts L″(C) and LS′(C).

The inventors have found that the shear amount d is affected by parameters such as paperboard sheet paper quality, thickness, type, amount and shape of sheet warpage at time of sheet manufacture, sheet moisture content and temperature, and amount of slitter knife wear.

Among these, it also become apparent that the amount of slitter knife wear (amount of grinding) and the amount of paperboard sheet warpage greatly affect the amount of shearing.

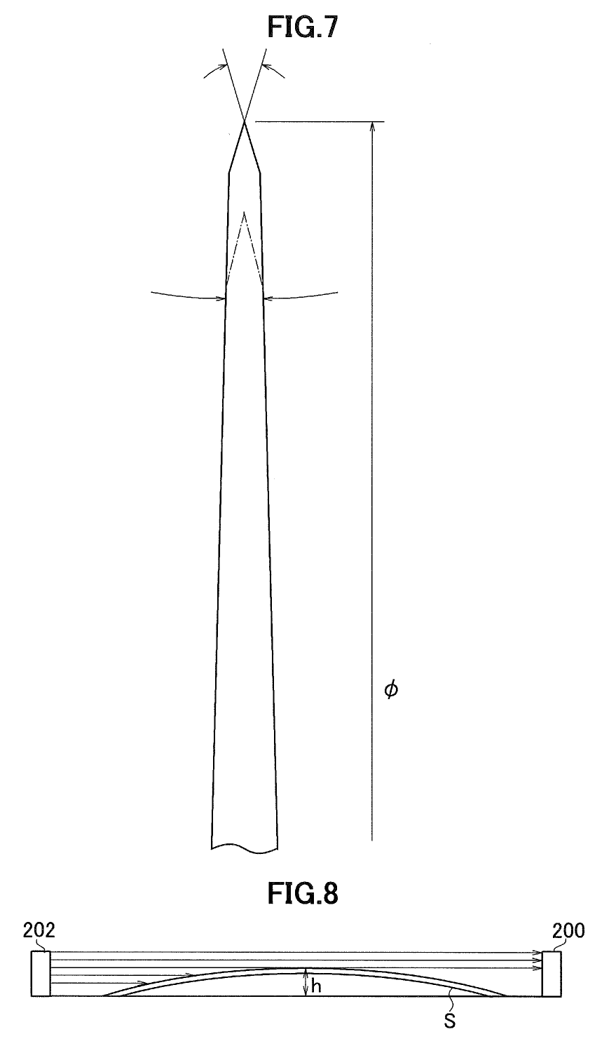

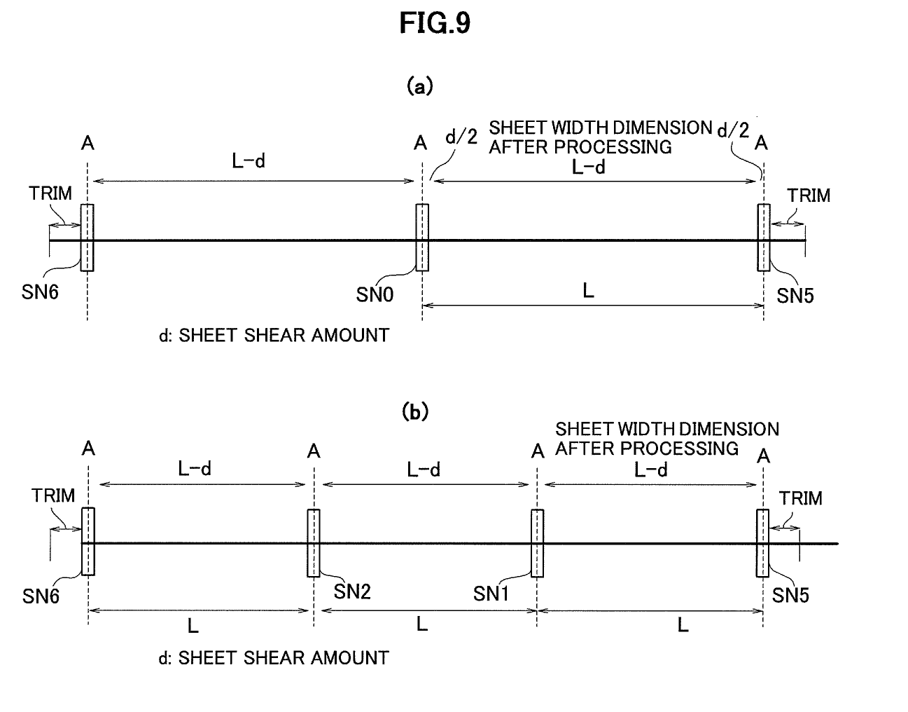

As the blade edge is repeatedly worn or ground, as shown by the dot and dash line in FIG. 7, the amount of slitter knife wear (amount of grinding) affects the amount of shearing, since this wear or grinding leads to cutting the paperboard sheet with the thick portion of the blade.

Since the correction amount thus increases with the amount of wear or the amount of grinding of the slitter knife blade edge, when the blade edge wear amount or grinding amount is large (when there is significant wear or grinding), that blade edge wear amount or grinding amount can be added to the positioning control in FIG. 5 in order to increase the above-described correction amount L″(C) and LS′(C) to enable further correction.

With respect to the amount of warpage of the paperboard sheet, flattening out a sheet which is slitted and scored in a warped state greatly affects the shearing amount d, since such flattening causes the positions of those slitting and scoring operations to move toward the outer sides relative to the center of the sheet.

Therefore the larger the amount of warpage, the more the above-described correction amounts L″(C) and LS′(C) may be reduced.

As shown in FIG. 8, for example, beam sensors 200 and 202 may be disposed on the upstream side of the slitter scorer apparatus 1, and the amount of warpage of the paperboard sheet S detected by measuring the height at which a beam is occluded by the paperboard sheet, so that further correction can be made to increase the above-described correction amounts L″(C) and LS′(C).

The moisture content and temperature of the paperboard sheet can also be detected using a moisture sensor and temperature sensor and, in combination with sheet paper quality data, further correction can be made to reduce the correction amounts L″(C) and LS′(C) in accordance with the amount of shrinkage of the paperboard sheet.

Furthermore, the amount of correction to the slitter and scorer used may be calculated sequentially from the drive side or calculated sequentially from the operating side.

Although the present invention has been explained with reference to a specific, preferred embodiment, one of ordinary skilled in the art will recognize that modifications and improvements can be made while remaining within the spirit and scope of the invention. The scope of the invention is determined solely by the appended claims.

1. A slitter scorer apparatus for cutting a paperboard sheet continuously supplied along a supply line and scoring the surface thereof, comprising:
a plurality of scorers parallely arrayed in the width direction relative to the paperboard sheet supply direction, for scoring the surface of a paperboard sheet;
a plurality of slitters parallely arrayed in the width direction relative to the paperboard sheet supply direction, having slitter knives for cutting the paperboard sheet;
a scorer width-direction moving means for independently moving each of the plurality of scorers in the width direction of the paperboard sheet;
a slitter width-direction moving means for independently moving each of the plurality of slitters in the width direction of the paperboard sheet;
and a control means for selecting a utilized slitter from among the plurality of slitters based on a production order, calculating a width-direction positional correction amount of the slitter knives of the selected slitter relative to an initial position matched to the desired paperboard sheet dimension in the width direction in accordance with the amount of shearing by the slitter knives, and controlling the slitter width-direction moving means to position the slitter knives at a position based on that calculated correction amount.

2. The slitter-scorer apparatus of claim 1, wherein the control means further controls the scorer width-direction moving means by selecting a utilized scorer from among the plurality of scorers based on a production order, calculating a scorer correction amount relative to an initial position matched to the desired paperboard sheet scoring position according to the above-described slitter knife width-direction positional correction amount, and positioning the scorer at a position based on that calculated correction amount.

3. The slitter-scorer apparatus of claim 2, wherein the control means calculates sequentially from one side in the width dimension of the slitter-scorer apparatus a first utilized scorer correction amount, and calculates sequentially from the other width dimension side of the slitter-scorer apparatus a second utilized scorer correction amount, then corrects those calculated first and second correction amounts so as to match the utilized scorer and the utilized slitter to the mechanical center, thereby calculating a slitter knife width direction position correction amount and scorer correction amount based on the amount of shearing by the slitter knives.

4. The slitter-scorer apparatus of claim 2, wherein the control means controls a slitter width-direction moving means and scorer width-direction moving means so as to simultaneously position the utilized slitter knives and the utilized scorers.

5. The slitter scorer apparatus of claim 1, further comprising a warpage detection sensor for detecting the amount of paperboard sheet warpage,
wherein the control means further corrects the amount of positional correction in the width direction of the slitter knives based on the amount of shearing by the slitter knives in accordance with the amount of warpage of the paperboard sheet detected by the warpage amount detection sensor.

6. A method for controlling the positional correction of slitter knives and scorers in a slitter scorer apparatus, comprising: a plurality of slitters having slitter knives for cutting a sheet parallely arrayed so as to be independently movable in the width direction relative to the direction of supply of the paperboard sheet; and a plurality of scorers for scoring the surface of a sheet parallely arrayed so as to be independently movable in the width direction relative to the direction of supply of the paperboard sheet: said method comprising the steps of:
selecting utilized slitters and utilized scorers from among the plurality of slitters and scorers based a production order;
calculating a first correction amount for each of the utilized scorers based on the amount of shearing by the slitter knives sequentially from one side in the width direction of the slitter scorer apparatus;
calculating a second correction amount for each of the utilized slitter knives based on the amount of shearing by the slitter knives sequentially from the other side in the width direction of the slitter scorer apparatus;
correcting the calculated first and second correction amounts to align the utilized scorers and the utilized slitter knives to the mechanical center, and calculating slitter knife correction amount and scorer correction amount relative to an initial position based on the desired dimension in the paperboard sheet width direction;
positioning the utilized slitters and the utilized scorers at a position based on that calculated correction amounts.
